(19) United States
(12) Patent Application Publication
(10) Pub. No.: US 2024/0069197 A1
(43) Pub. Date: Feb. 29, 2024

(54) Scanning Flash Light Detection And Ranging Apparatus and its Operating Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 17/900,864

(22) Filed: Aug. 31, 2022

(51) Int. Cl. G01S 17/10; G01S 7/481; G01S 7/4865

(52) U.S. Cl. CPC G01S 17/10; G01S 7/4815; G01S 7/4816; G01S 7/4817; G01S 7/4865

(57) ABSTRACT

A scanning flash light detection and ranging apparatus includes a light transmitter, a beam steering unit configured to steer pulse light and the reflected pulse light, and a light receiver configured to capture the reflected pulse light. The light transmitter includes a plurality of light sources. Each of the plurality of light sources is configured to emit the pulse light. The pulse light is non-visible. The reflected pulse light represents the pulse light reflected by at least one object. The pulse light incident on the beam steering unit and the reflected pulse light deflected by the beam steering unit are parallel or coaxial. Alternatively, the pulse light deflected by the beam steering unit and the reflected pulse light incident on the beam steering unit are parallel or coaxial. The light receiver is a Geiger mode avalanche photodiode receiver including a plurality of light detectors.

### BACKGROUND OF THE INVENTION

### 1. Field of the Invention

The present invention relates generally to systems and methods that use scanning mirror based Light Detection And Ranging (LiDAR) for surveying a surrounding environment, and more particularly to systems and methods that use scanning mirror with flash LiDAR for obstacle detection and avoidance in a surrounding environment.

### 2. Description of the Prior Art

With the advent of Autonomous Driving Assist System (ADAS), automobiles demand systems capable of reliably sensing and identifying objects, hazards, and obstacles in navigation. Among all systems, a Light Detection and Ranging (LiDAR) system is an example of system that measures distances to objects by emitting non-visible laser to objects within the Field of View (FOV) and receiving returned laser signal such that distances to objects are computed by measuring time delay between emitted and returned laser.

Among all specifications, spatial angle resolution is critical in LiDAR design. There is still room for improvement when it comes to LiDAR design.

### SUMMARY OF THE INVENTION

It is therefore a primary objective of the present invention to disclose a scanning flash LiDAR system and method that comprises a light transmitter, an opto-mechanical beam steering device and a plurality of Geiger mode avalanche photodiodes that generates high spatial angle resolutions within field of view where an opto-mechanical beam steering device could be MEMS resonant mirror or mechanical driven rotating mirror/prism.

An embodiment of the present invention provides a scanning flash LiDAR apparatus, comprising a light transmitter, wherein the light transmitter comprises a plurality of light sources, each of the plurality of light sources is configured to emit pulse light, and the pulse light is non-visible; a beam steering unit, configured to steer the pulse light and reflected pulse light, wherein the reflected pulse light represents the pulse light reflected by at least one object; and a light receiver, configured to capture the reflected pulse light, wherein the light receiver is a Geiger mode avalanche photodiode receiver comprising a plurality of light detectors, and the light transmitter, the beam steering unit, and the light receiver are disposed corresponding to each other, wherein the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial.

Another embodiment of the present invention provides a light detection and ranging (LiDAR) operating method, for a scanning flash LiDAR, comprising emitting pulse light from a light transmitter of the scanning flash LiDAR, wherein the light transmitter comprises a plurality of light sources, each of the plurality of light sources is configured to emit the pulse light, and the pulse light is non-visible; steering reflected pulse light and the pulse light using a beam steering unit of the scanning flash LiDAR, wherein the reflected pulse light represents the pulse light reflected by at least one object; and capturing the reflected pulse light by a light receiver of the scanning flash LiDAR, wherein the light receiver is a Geiger mode avalanche photodiode receiver comprising a plurality of light detectors, wherein the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 5 are schematic diagrams of LiDAR apparatuses according to embodiments of the present invention.

FIG. 6 shows a FOV of a LiDAR apparatus for a one-laser-one-detector setup.

FIG. 7 shows a diagram of FOV of a LiDAR apparatus without beam steering.

FIG. 8 is a schematic diagram of a LiDAR apparatus according to an embodiment of the present invention.

FIG. 9 shows two different configurations of LiDAR apparatuses according to embodiments of the present invention.

FIG. 10 to FIG. 15 are schematic diagrams of LiDAR apparatuses according to embodiments of the present invention.

FIG. 16 is a schematic diagram of an electro-optical device according to an embodiment of the present invention.

FIG. 17 is a schematic diagram of a LiDAR system according to an embodiment of the present invention.

### DETAILED DESCRIPTION

The LiDAR system measures distances to object(s) by emitting non-visible laser pulse to object(s) in the surrounding environment, and receiving returned pulse signal after reflected from the object(s). Distances to object(s) are computed using time of flight method by measuring time delay between emitted and returned pulsed laser. The LiDAR system provides a 3D representation of the object(s) known as point cloud data which is formed by collecting distances to object(s) data in a 2-D space. It is desirable feature of a LiDAR system to obtain a high spatial resolution point cloud data in one frame. This invention aims at disclosing a scanning flash LiDAR system and method that comprises a light transmitter, an opto-mechanical beam steering device and a plurality of Geiger mode avalanche photodiodes that generates point cloud data with high spatial resolution.

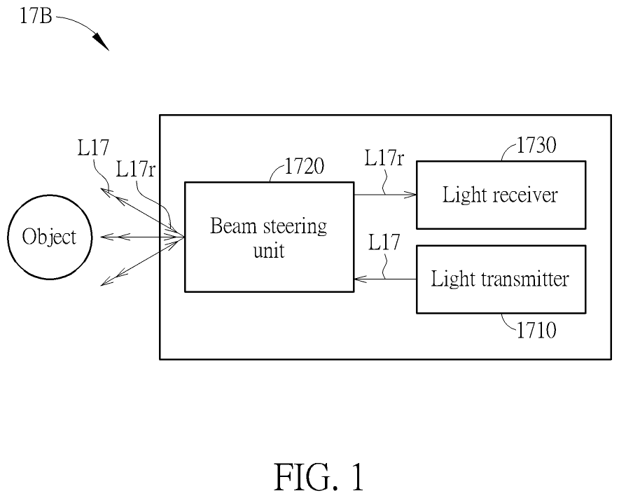

FIG. 1 is a schematic diagram of a LiDAR apparatus 17B according to an embodiment of the present invention. The LiDAR apparatus 17B may be a scanning flash LiDAR apparatus. The LiDAR apparatus 17B may include a light transmitter 1710, a beam steering unit 1720, and a light receiver 1730.

The light transmitter 1710 includes light sources. Each light source is configured to emit pulse light L17 (or a pulse light beam). The pulse light L17 is non-visible.

The beam steering unit 1720 is configured to steer the pulse light L17 and reflected pulse light L17r which represents the pulse light L17 reflected by object(s). The pulse light L17 incident on the beam steering unit 1720 and the reflected pulse light L17r deflected by the beam steering unit 1720 are parallel or coaxial; alternatively, the pulse light L17 deflected by the beam steering unit 1720 and the reflected pulse light L17r incident on the beam steering unit 1720 are parallel or coaxial.

The light receiver 1730 is configured to capture the reflected pulse light L17r (or the reflected pulse light beam). The light receiver 1730 is a Geiger mode avalanche photodiode receiver including a plurality of light detectors (e.g., Geiger mode avalanche photodiodes). A Geiger mode avalanche photodiode may be/include a silicon based single photon avalanche diode (SPAD), a silicon photomultiplier, a Germanium-on-silicon SPAD, or an InGaAs/InP SPAD.

The light transmitter 1710, the beam steering unit 1720, and the light receiver 1730 are disposed corresponding to each other.

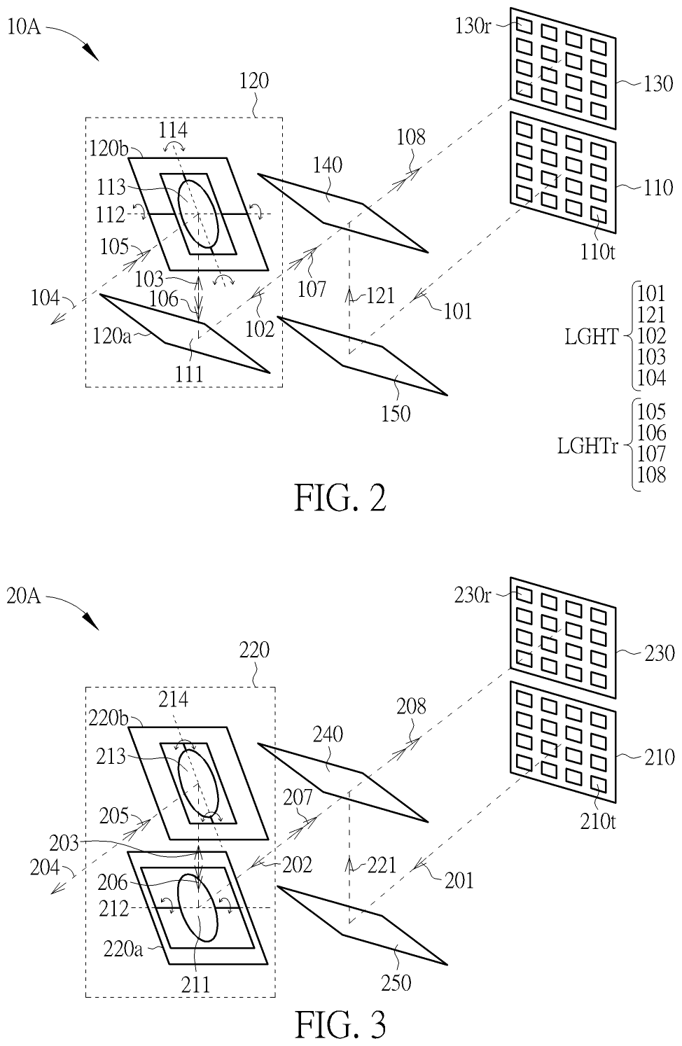

FIG. 2 is a schematic diagram of a LiDAR apparatus 10A according to an embodiment of the present invention. The LiDAR apparatus 10A may include a light transmitter 110, a beam steering unit 120, a light receiver 130, an optical separator 140, and an optical deflector 150. The light transmitter 110 may include a plurality of individual light sources 110t. Each light source 110t is configured to emit a pulse light (beam) (such as a pulse light beam LGHT, which travels along optical path segments 101, 121, 102, 103, and 104). Therefore, the light transmitter 110 may illuminate with precision beams of light instead of a flood.

The pulse light incident on the beam steering unit 120 (shown as the optical path segment 102) and the reflected pulse light deflected by the beam steering unit 120 (shown as an optical path segment 107) are parallel or coaxial, and the pulse light deflected by the beam steering unit 120 (shown as the optical path segment 104) and the reflected pulse light incident on the beam steering unit 120 (shown as an optical path segment 105) are parallel or coaxial.

The light sources 110t may be arranged in a two-dimensional array to emit the pulse light beams at once as a flash LiDAR. However, the present invention is not limited thereto. For example, the light sources 110t may be in a form of column or row. The light source 110t may be individually activated or able to be individually activated. The light source 110t may illuminate homogeneously.

The wavelength of the pulse light (beam) is but not limited to 840 nanometers (nm), 905 nm, 940 nm, 1330 nm, or 1550 nm.

The light transmitter 110 may be an edge emitting laser diode source transmitter, or a vertical cavity surface emitting laser (VCSEL) source transmitter or a photonic crystal surface emitting laser (PCSEL) source transmitter to emit the pulse light beams, but is not limited thereto.

The light receiver 130 may include a plurality of individual light detectors 130r. Each light detector 130r is configured to capture a reflected pulse light (beam) (such as a reflected pulse light beam LGHTr, which travels along optical path segments 105, 106, 107, and 108). Each reflected pulse light beam (e.g., the reflected pulse light beam LGHTr) represents one pulse light beam reflected/scattered by one object (e.g., the pulse light beam LGHT).

The light detector 130r may be illuminated by the reflected pulse light beams (shown as the optical path segment 108) and actively collecting the reflected pulse light beams simultaneously as a flash LiDAR. The data capture rate of the LiDAR apparatus 10A may be fast.

The light detectors 130r may be arranged in a two-dimensional array or a one-dimensional array (such as a row or column) and can be individually configured such that it collects the reflected pulse light beams reflected/scattered by object(s) in an array or in a column or in a row.

The light detectors 130r may be a Geiger mode avalanche photodiode receiver, but is not limited thereto.

The optical separator 140 is configured to separate the reflected pulse light beams from the pulse light beams so that one pulse light beam follows the optical path segments 121, 102 but the reflected pulse light beam follows the optical path segments 108, 107. The optical separator 140 may be a beam splitter or polarizing beam splitter, but is not limited thereto.

As shown in FIG. 2, the pulse light beams from the light transmitter 110 may be redirected by the optical separator 140 (e.g., leading to a 90-degree deflection with respect to the optical path segment 121); the reflected pulse light beams toward the light receiver 130 may passes through the optical separator 140 without changing direction with respect to the optical path segment 107 (but possibly with beam offset or spatial shift).

The optical deflector 150 is configured to bend the pulse light beams from the light transmitter 110 toward the optical separator 140. In this case, the light transmitter 110 may be disposed parallel to the light receiver 130; the optical path segment 101 may be parallel to the optical path segment 108.

The beam steering unit 120 is configured to steer the reflected pulse light beams reflected/scattered by object(s) and the pulse light beams emitted from the light transmitter 110 as a scanning LiDAR (such as a mechanical LiDAR).

The beam steering unit 120 may include at least one steering component (e.g., steering components 120a and 120b). At least one steering component (e.g., the steering component 120b) of the beam steering unit 120 is locally movable and may be physically or virtually pivoted at a fixed point/axis. The beam steering unit 120 may further include non-movable steering component(s) (e.g., the steering component 120a) in addition to the at least one movable steering component, but is not limited thereto (namely, the steering component 120a may be omitted).

In FIG. 2, the steering component 120a may turn the pulse light beam (corresponding to the light source 110t at the top left) and the reflected pulse light beam (corresponding to the light detector 130r at the top left) aside from their straight courses (i.e., the optical path segments 102 and 106 respectively). The pulse light beam (corresponding to the light source 110t at the top left) incident on the steering component 120a along the optical path segment 102 and the corresponding reflected pulse light beam (corresponding to the light detector 130r at the top left) deflected/reflect by the steering component 120a along the optical path segment 107 may be coaxial as shown in FIG. 2 or parallel.

In FIG. 2, the steering component 120b may turn the pulse light beam (corresponding to the light source 110t at the top left) and the reflected pulse light beam (corresponding to the light detector 130r at the top left) aside from their straight courses (i.e., the optical path segments 103 and 105 respectively). The pulse light beam (corresponding to the light source 110t at the top left) deflected/reflect by the steering component 120b along the optical path segment 104 and the corresponding reflected pulse light beam (corresponding to the light detector 130r at the top left) incident on the steering component 120b along the optical path segment 105 may be coaxial as shown in FIG. 2 or parallel.

The steering component 120a may have a reflective mirror surface 111. The steering component 120a is stationary.

The steering component 120b may be a 2D MEMS resonant mirror. The steering component 120b according to this embodiment may comprise a reflective mirror surface 113, a first flexure that scans in a first axis 114 at a faster frequency f_{fast} (for example 900 Hz) and a second flexure that scans in a second axis 112 which is orthogonal to first axis at a slower frequency f_{slow}. The FOV of a MEMS resonant mirror (e.g., the steering component 120b) may be 30 degrees (horizontal)×30 degrees (vertical).

As a result, the pulse light beams from the light transmitter 110 are deflected/reflected by the beam steering unit 120 before the pulse light beams bounce off object(s) to form the reflected pulse light beams. After the reflected pulse light beams are bent back from the object(s), the reflected pulse light beams are deflected/reflect by the beam steering unit 120 and captured by the light receiver 130. The pulse light and the reflected pulse light may be deflected/reflect by the beam steering unit 120 as the beam steering unit 120 scans in either a one-dimensional field of view or a two-dimensional field of view.

In a word, the LiDAR apparatus 10A may leverage coaxial optical mechanism, meaning that the light transmitter 110 and the light receiver 130 share the same beam steering unit 120. Within the beam steering unit 120, the trajectory that the light from the light transmitter 110 follows (i.e., the optical path segments 102-104) may be identical/similar to the trajectory that the light toward the light receiver 130 follows (i.e., the optical path segments 107-105). As optical paths are the same within the beam steering unit 120 for the pulse light beam and the reflected pulse light beam, there may be no angular deviation, which improves ranging accuracy and facilitate size reduction.

The direction of the light is controlled by the beam steering unit 120 to scan object(s). In an embodiment, the beam steering unit 120 may rotate alone in the LiDAR apparatus 10A, and the beam steering unit 120 may be placed in the optical path between the light transmitter 110 or the light receiver 130 and object(s) to deflect the light.

The light transmitter 110 may not illuminate the entire field of view of the LiDAR apparatus 10A but part of the entire field of view of the LiDAR apparatus 10A. The LiDAR apparatus 10A may scan the entire field of view using the beam steering unit 120. The beam steering unit 120 enables the LiDAR apparatus 10A to sequentially go from one area to another over the scene quickly to complete the whole scene.

The reflected pulse light beams reflected/scattered by object(s) are imaged onto the light receiver 130 including the light detectors 130r. The time delay(s) between the pulse light beams emitted from the light transmitter 110 and the reflected pulse light beams received by the light receiver 130 is/are calculated for the light detectors 130r, respectively, to measure the distance(s) between the LiDAR apparatus 10A and the object(s). The data collected by the light receiver 130 over a predefined time period (e.g., at least part of the length of time for the beam steering unit 120 to go through one cycle) may be processed and converted into a frame of data to present one image. For example, the whole image for a scene may be captured after the beam steering unit 120 completes its scan trajectory.

The wavelength of one of the pulse light beams may be in a range of 840 nm to 1550 nm, but is not limited thereto. The wavelength of one of the pulse light beams may be 840 nm, 905 nm, 940 nm, 1550 nm, or a combination thereof.

In an embodiment, the optical deflector 150 may be absent from the LiDAR apparatus 10A as the configuration of the light transmitter 110 and the light receiver 130 varies. In an embodiment, the optical separator 140 may be absent from the LiDAR apparatus 10A if necessary.

The light transmitter 110, the beam steering unit 120, and the light receiver 130 are disposed corresponding to each other. The light transmitter 110, the beam steering unit 120, and the light receiver 130 may be mounted on/under a base but is not limited thereto. The relative configuration/distance between the light transmitter 110 and the beam steering unit 120, between the light transmitter 110 and the light receiver 130, or between the beam steering unit 120 and the light receiver 130 may not be a function of time. The light transmitter 110, the beam steering unit 120, and the light receiver 130 may be disposed adjacent to each other.

FIG. 3 is a schematic diagram of a LiDAR apparatus 20A according to another embodiment of the present invention. The LiDAR apparatus 20A may include a light transmitter 210 with individual light sources 210t, a beam steering unit 220, a light receiver 230 with individual light detectors 230r, an optical separator 240, and an optical deflector 250 where the beam steering unit 220 may further comprise a steering component 220b (referred to as a first 1D MEMS resonant mirror 220b) and a steering component 220a (referred to as a second 1D MEMS resonant mirror 220a). The first 1D MEMS mirror 220b may comprise a reflective mirror surface 213 and a flexure resonating around a first axis 214 at fast frequency f_{fast}. The second 1D MEMS mirror 220a may comprise a reflective mirror surface 211 and a flexure resonating around a second axis 212 at slow frequency f_{slow}. A pulse light (beam) from one light source 210t toward one light detector 230r may travel along optical path segments 201-208.

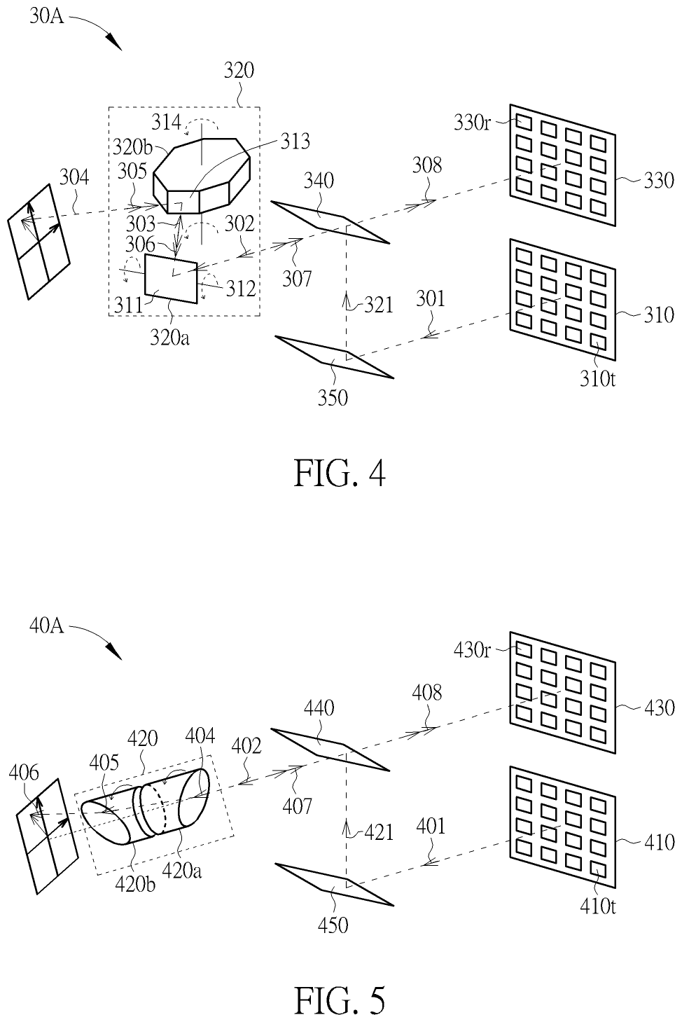

FIG. 4 is a schematic diagram of a LiDAR apparatus 30A according to yet another embodiment of the present invention. The LiDAR apparatus 30A may include a light transmitter 310 with individual light sources 310t, a beam steering unit 320, a light receiver 330 with individual light detectors 330r, an optical separator 340, and an optical deflector 350.

The beam steering unit 320 may further comprise a steering component 320b (referred to as a polygon mirror) and a steering component 320a (referred to as a mechanical mirror). The polygon mirror 320b may comprise multiple reflective mirror surfaces 313 rotating around a first axis 314. The mechanical mirror 320a may comprise a reflective mirror surface 311 and a flexure scanning around a second axis 312.

A pulse light (beam) from one light source 310t toward one light detector 330r may travel along optical path segments 301-308.

FIG. 5 is a schematic diagram of a LiDAR apparatus 40A according to yet another embodiment of the present invention. The LiDAR apparatus 40A may include a light transmitter 410 with individual light sources 410t, a beam steering unit 420, a light receiver 430 with individual light detectors 430r, an optical separator 440, and an optical deflector 450.

The beam steering unit 420 may further comprise a steering component 420b (referred to as a first Risley prism) and a steering component 420a (referred to as a second Risley prism). Both the Risley prism 420a, and 420b may constitute a pair of wedge-shaped prisms aligned sequentially along its rotational axis (for example, parallel to an optical path segment 402) to scan a two dimensional FOV. The light transmitter 410 of the LiDAR apparatus 40A may send out a pulse light (beam) traveling through the prism 420a of the beam steering unit 420, where the pulse light (beam) may be bent at an angle (for example, from an optical path segment 404 to an optical path segment 405) determined by the refractive index of the prism material and the wedge angle of the prism 420a. When the prism 420a is resolved, the pulse light (beam) is steered in a circular cone. Next the steered pulse light (beam) from the prism 420a enters the prism 420b of the beam steering unit 420 where the prism 420b may bend the pulse light (beam) at another angle (for example, from an optical path segment 405 to an optical path segment 406) to form a Lissajous scan pattern determined by the revolution speed and revolving angles of the prisms 420a and 420b.

A pulse light (beam) from one light source 410t toward one light detector 430r may travel along optical path segments 401-408.

FIG. 7 shows a diagram of FOV of a LiDAR apparatus 60A without beam steering. Without beam steering unit, the spatial resolution is determined by field of view over number of Geiger mode avalanche photodiode pixels of a light receiver of the LiDAR apparatus 60A. For example, if the FOV of the LiDAR apparatus 60A is 30 degrees (horizontal) (as shown by a span 620)×30 degrees (vertical) (as shown by a span 630) and there are 128 (or M)×64 (or N) pixels of (Geiger mode avalanche photodiode) light detectors, then the resolution is 0.24 degrees (horizontal) and 0.47 degrees (vertical) or 128×64 (8192 denoted as M×N) points per flash and there is only one flash in one frame. Here, M and N are integers. In other words, the FOV of one (Geiger mode avalanche photodiode) light detector of the LiDAR apparatus 60A may be 0.24 degrees (horizontal) (as shown by a span 650)×0.47 degrees (vertical) (as shown by a span 640). For a flash LiDAR, the frame rate may be in range of micro seconds (for example, 12.5 us) which means there are 1/12.5=80k fps (frame per second) if all 8192 Geiger mode avalanche photodiode pixels are turned on and collect signals at the same time. In summary, a flash LiDAR has poor spatial resolution (0.24 degrees×0.47 degrees) but has great temporal resolution (80k Hz). However, in circuits where all Geiger mode avalanche photodiode share one sense amplifier, only one Geiger mode avalanche photodiode turns on at one time, temporal resolution drops to 10 Hz (=80k/128/64).

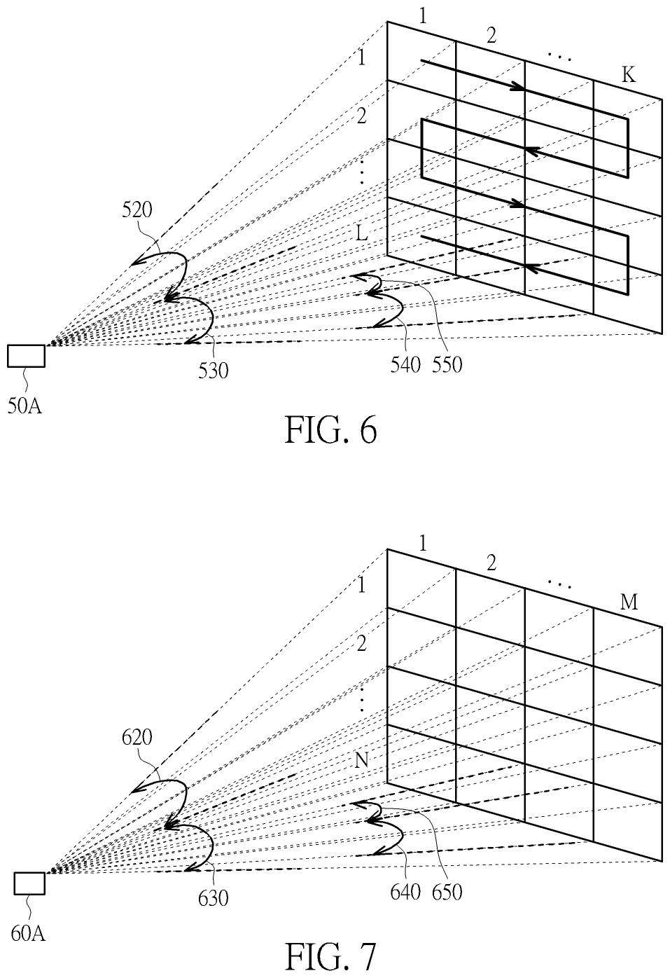

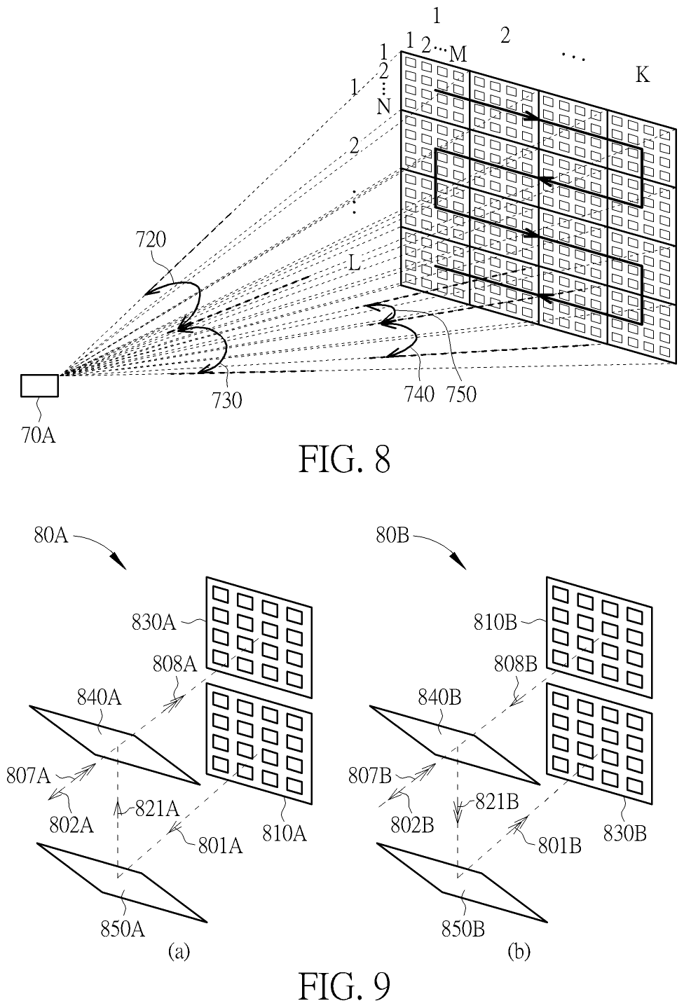

In the present invention, a light transmitter and a light receiver of a LiDAR apparatus of the present invention (which includes a beam steering unit such as a 2-D MEMS resonant mirror) may not be moving and only the beam steering unit is scanning. The beam steering unit (e.g., the 2D MEMS resonant mirror 120b) may comprise a first flexure that scans in a first axis at a faster frequency f_{fast} (for example 900 Hz) and a second flexure that scans in a second axis which is orthogonal to first axis at a slower frequency f_{slow}. The FOV of beam steering unit (e.g., the 2D MEMS resonant mirror 120b) may be 30 degrees (horizontal)×30 degrees (vertical). The slow axis frequency f_{slow} determines frame rate. The frame rate may be 30 Hz. The number of horizontal scanning lines is determined by f_{fast}/30 Hz=900/30=30 lines which means the vertical resolution is 30 degrees/30 lines=1 degree. For a LiDAR apparatus measuring a distance of 200 meters (m), it takes 2×200 m/(3×10⁸ ms⁻¹)=1.33 us for the light receiver to receive pulse light. In one horizontal scanning time (1/900/2 Hz=0.55 ms), there are a maximum of 0.55 ms/1.33 us=413 points over horizontal FOV (30 degrees) which yields 30/413=0.073 degrees. Here, the speed of light in vacuum is assumed to be 3×10⁸ ms⁻¹. FIG. 6 shows a FOV of a LiDAR apparatus 50A for a one-laser-one-detector setup (which includes only one light source within its light transmitter and only one light detector within its light receiver). There are 413 (or K) points (horizontal) (as shown by a span 520)×30 (or L) points (vertical) (as shown by a span 530)=12390 (or K×L) points or equivalent 12390 (or K×L) numbers of miniaturized FOV (as shown by the spans 540, 550). Spatial resolution of 0.073 degrees (horizontal) (as shown by a span 550)×1 degree (vertical) (as shown by a span 540) is achieved in this one-laser-one-detector setup. Here, K and L are integers. However FIG. 8 shows a LiDAR apparatus 70A according to an embodiment of the present invention. The LiDAR apparatus 70A may comprise a plurality of light sources within its light transmitter (e.g., 128 (or M)×64 (or N)=8192 (or M×N) light sources) and (Geiger mode avalanche photodiode) light detectors within its light receiver (e.g., 8192 (or M×N) light detectors) using a beam steering unit (e.g., a MEMS resonant mirror beam steering unit) over its entire FOV (as shown by spans 720, 730). Over the entire FOV, there are 413 (or K)×30 (or L) numbers of miniaturized FOV. In each miniaturized FOV (as shown by spans 740, 750), there are 8192 points. Therefore the horizontal resolution is 413 (or K) miniaturized FOV×128 (or M) points=52864 (or K×M) points over 30 degrees FOV, and thus the horizontal resolution is roughly 30/52864=0.57×10⁻³ degrees. The vertical resolution is 30 (or L) miniaturized FOV×64 (or N) points=1920 (or L×N) points over 30 degrees FOV, and thus the vertical resolution is roughly 30/1920=15.6×10⁻³ degrees. Therefore, there are 52864 points (or K×M)×1920 points (or L×N) over FOV (30 degrees×30 degrees) at frame rate of 30 Hz. Therefore the spatial resolution increases by M×N times (compared to that in FIG. 7) but temporal resolution is poor (decreases by M×N times) assuming all Geiger mode avalanche photodiode light detectors turn on and collect the reflected pulse light at the same time. To produce 12390 (or K×L) miniaturized FOV, the present invention may leverage coaxial optical mechanism (as shown in FIG. 2).

In an embodiment, the rotation angle of a beam steering unit of a LiDAR apparatus in the present invention may be in a range of 0.073 to 1 degree(s). In an embodiment, the rotation angle of a beam steering unit of a LiDAR apparatus in the present invention may be but not limited to 0.073 degrees (horizontal) (as shown by the span 750) or 1 degree (vertical) (as shown by the span 740). For example, a pulse light (beam) from the LiDAR apparatus, which travels along, for example, the optical path segment 104, may be turned by a fixed angle of 0.073 degrees (horizontal) or 1 degree (vertical) at a time. The ratio of the rotation angle to the FOV of the LiDAR apparatus may be but not limited to 0.073/30=0.0024 (horizontal) or 1/30=0.033 (vertical).

In an embodiment, a LiDAR apparatus may switch between large FOV (e.g., 30 degrees (horizontal)×30 degrees (vertical) as shown by the spans 720, 730) and small FOV (e.g., 0.073 degrees (horizontal) xl degree (vertical) as shown by the spans 740, 750). A beam steering unit of a LiDAR apparatus may make movement(s) to achieve large FOV and may be stationary to achieve small FOV depending on scenarios. Generally, although coaxial optical mechanism may improve accuracy, it may put a strict limit on FOV. Therefore, when the beam steering unit is not actuated/scanning, the FOV of the LiDAR apparatus may be limited (to the miniaturized FOV mentioned above). The beam steering unit may be adjusted to certain arrangement/orientation to steer pulse light beams towards a particular direction without completing its scan trajectory when one requires rapid detection/ranging in the direction with small FOV instead of scanning the entire FOV for the whole scene. The (Geiger mode avalanche photodiode) light detectors of a light receiver of the LiDAR apparatus ensure higher resolution even if the beam steering unit is stationary.

FIG. 9 shows two different configurations of LiDAR apparatuses 80A and 80B according to embodiments of the present invention. In a reflective configuration as shown in (a) of FIG. 9, a light transmitter 810A of the LiDAR apparatus 80A may transmit a pulse light (beam) along an optical path segment 801A to an optical deflector 850A of the LiDAR apparatus 80A, which may reflect the pulse light (beam) along the optical path segment 801A to an optical separator 840A of the LiDAR apparatus 80A along an optical path segment 821A. The optical separator 840A has two functions: 1) It may reflect the pulse light (beam) along the optical path segment 821A to follow the optical path segment 802A; 2) It may allow the reflected pulse light (beam) along the optical path segment 807A to propagate toward a light receiver 830A of the LiDAR apparatus 80A along an optical path segment 808A. In a transmissive configuration as shown in (b) of FIG. 9, a light transmitter 810B of the LiDAR apparatus 80B may transmit a pulse light (beam) along an optical path segment 808B to an optical separator 840B of the LiDAR apparatus 80B, which allows the pulse light (beam) to propagate along an optical path segment 802B. The optical separator 840B may also reflect the reflected pulse light (beam) along an optical path segment 807B to an optical deflector 850B of the LiDAR apparatus 80B along an optical path segment 821B. The optical deflector 850B then reflect the pulse light (beam) along the optical path segment 821B to a light receiver 830B of the LiDAR apparatus 80B along an optical path segment 801B.

In a LiDAR apparatus of the present invention, a light transmitter may be a bottom-emitting VCSEL laser, where output light is emitted from the bottom substrate side. In the invention, we disclose the use of VCSEL as plurality of light transmitter sources. Typical laser diode is edge emitting where laser is emitted from the side of the substrate. Therefore array of laser diodes cannot be fabricated monolithically. Array of discrete laser diodes can only be assembled in a Printed Circuit Board substrate which yields much larger array size and poor alignment due to poor tolerance from pick-and-place machine used in the PCB assembly line. On the other hand, since VCSEL emits laser light from the surface of the substrate either top emitting or bottom emitting, VCSEL technology allows fabrication of multitude of lasers in forms of array (>1K).

A VCSEL laser may be fabricated on a semi-conductor substrate. An n-type partially reflective distributed Bragg reflector (DBR) may be first placed on the substrate. After that, a highly reflective p-type DGR, an oxide aperture, and an active area form a mesa structure on top of the n-type DBR. A top p-type contact and a bottom n-type contact provide electrical current to the active area to generate an output light. An emission aperture is defined in the bottom contact to allow the output light to emerge from the bottom substrate side of the VCSEL. This VCSEL technology may be fabricated one VCSEL pixel or multiple pixels in forms of one-dimensional or two-dimensional arrays on the same substrate.

In a LiDAR apparatus of the present invention, a light transmitter may be a VCSEL cluster comprising a cluster formed by 21 single VCSEL apertures on a semiconductor chip. Each VCSEL device is connected together such that when they are biased, an array of laser pulses fired through these apertures at the same time. The VCSEL technology allows the fabrication of a plurality of VCSEL devices. Alternatively, a light transmitter may be a VCSEL cluster in a two-dimensional array comprising a cluster of 5×5 VCSEL devices. Five top row electrodes are placed vertically and five bottom column electrodes are placed horizontally such that when a voltage is applied between one top row electrode and one bottom column electrode, only one individual VCSEL device is activated to fire up a laser beam. Such VCSEL array design can be configured to generate flash light pulse(s) either 1) individually meaning one laser at a time; 2) in a row (s); 3) in a column(s); or 4) in a whole array at the same time. The pulse light (beam) could have wavelengths of 840, 905, 940, 1550 nm.

One of the major problems of firing up the whole array of lasers is overheating which might lead to device damage or laser frequency shift. Temperature sensor(s) is suggested to be placed in the vicinity to monitor local temperature or local heating at the VCSEL array. Heater or TEC might be placed and with temperature sensor forming feedback loop to maintain local array temperature.

Typically VCSEL generates less optical power output than discrete laser diode; therefore commonly used avalanche photo diode (APD) might not be sufficient to measure returned laser pulse due to its poor signal sensitivity. A LiDAR apparatus of the present invention may include a Geiger mode avalanche photodiode detector with higher sensitivity than an APD.

An APD may be commonly used as a photo-detector, where the APD output a current that is proportional to the light intensity incident on the detector. However APD need to be backed by several analog circuits such as trans-impedance amplifier(s), operational amplifier(s), and A/D converter(s). In addition, an APD also calls for high reverse voltage(s) that must be generated by a discrete high voltage supply. Most importantly, an APD is sufficient to measure returned pulse from VCSEL array due to poor signal to noise ratio.

On the other hand, poor signal to noise ratio can be mitigated by using a Geiger mode avalanche photodiode. A Geiger mode avalanche photodiode is a semiconductor device having a p-n junction that is reverse biased at a voltage that exceeds the breakdown voltage of the p-n junction (i.e. in Geiger mode) such that when a single photon is injected into the depletion layer, it generates a single electron-hole pair that in turns triggers a self-sustaining electric current multiplication producing a detectable avalanche current. The arrival time of the photon is indicated by the leading edge of the avalanche current. The Geiger mode avalanche photodiode is connected to a quenching circuit that senses the leading edge of the avalanche current and quenches the avalanche current by lowering the bias voltage to the breakdown voltage. During quenching, the Geiger mode avalanche photodiode does not detect additional photon thus experience a dead time which could last for a few nano-second equivalent to 1.5 m of detection distance. After that, the Geiger mode avalanche photodiode bias is then raised by the power-supply circuit to original bias voltage so that the next photon can be detected.

In addition, both VCSELs and Geiger mode avalanche photodiodes each fabricated monolithically using standard process simplifies manufacturing and assembly process.

MEMS Mirror

In a MEMS mirror of a LiDAR apparatus of the present invention, it comprises a reflective mirror surface, a first flexure, a gimbal, a second flexure, and a substrate.

An MEMS mirror may be one-dimensional or two-dimensional.

An MEMS mirror may be driven by several mechanisms such as electrostatic, electromagnetic, piezoelectric, or thermal mechanism.

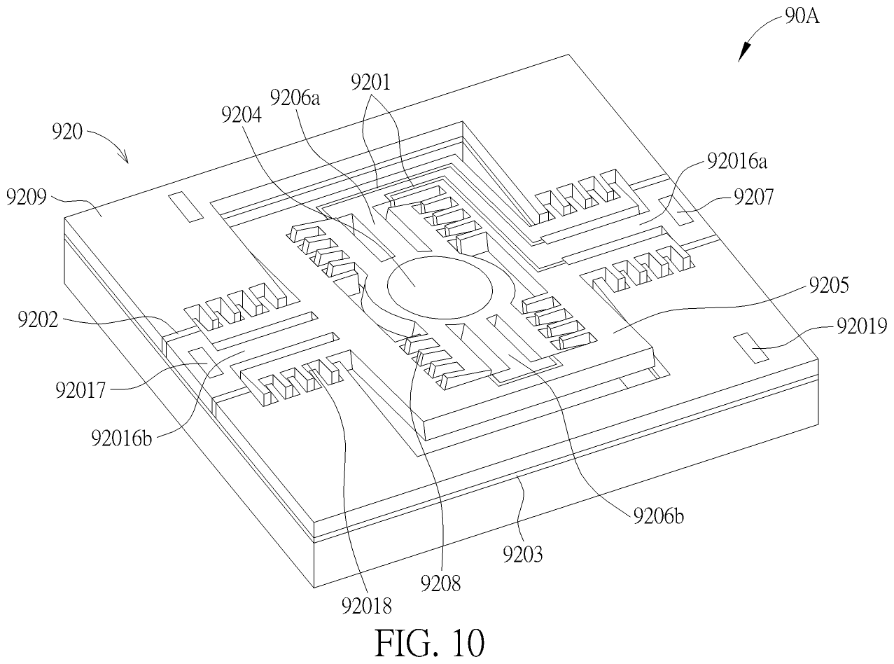

FIG. 10 is a schematic diagram of a LiDAR apparatus 90A according to an embodiment of the present invention. The LiDAR apparatus 90A may include a beam steering unit 920 such as an electrostatic-driven two-axis MEMS micro-mirror apparatus. The beam steering unit 920 may include a reflective micro-mirror 9204, where the micro-mirror 9204 is supported to a frame 9205 by two fast-axis torsional beams 9206a, 9206b. The micro-mirror 9204 and the fast-axis torsional beams 9206a, 9206b are electrically connected to an inner mirror pad 9207 and are insulated from the frame 9205 by an insulation layer 9201. The micro-mirror 9204 comprises fast-axis comb electrodes 9208 while the frame 9205 comprises the corresponding counterpart of the fast-axis comb electrodes 9208. The frame 9205 is in turn supported by two second orthogonal slow-axis torsional beams 92016a, 92016b to a device layer 9209. The frame 9205 also comprises slow-axis comb electrodes 92018 and the corresponding counterpart of the slow-axis comb electrodes 92018 is located at the device layer 9209. Electrically, the frame 9205 is connected to the frame mirror pad 92017 and is insulated from the device layer 9209 by an insulation layer 9202. The device layer 9209 is electrically connected to a device layer pad 92019. The device layer 9209 is also electrically insulated from the substrate by an insulation layer 9203. To operate, when an “AC” voltage is applied to the inner mirror pad, the micro-mirror 9204 rotates around the slow-axis torsional beam while frame mirror pad is connected to electrical ground. When another “AC” voltage is applied to the device layer pad 92019, the micro-mirror 9204 rotates around the fast-axis torsional beam.

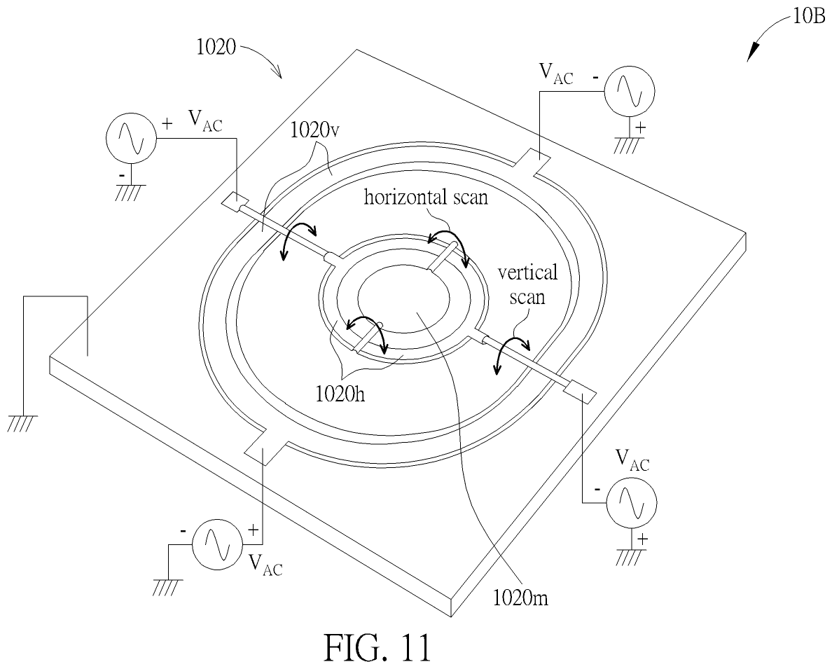

FIG. 11 is a schematic diagram of a LiDAR apparatus 10B according to an embodiment of the present invention. The LiDAR apparatus 10B may include a beam steering unit 1020 such as a piezoelectric-driven two-axis MEMS micro-mirror apparatus. The beam steering unit 1020 may include a reflective micro-mirror 1020m, where the micro-mirror 1020m is supported to the gimbal by two first pivoting flexures. The gimbal is in turn supported by two second orthogonal pivoting flexures to a substrate. The vertical scan is controlled by a piezoelectric actuator 1020v and the horizontal scan is controlled by another piezoelectric actuator 1020h. By applying oscillating electrical voltages of resonant frequency to the piezoelectric actuators, the mirror is caused to oscillate with large field of view.

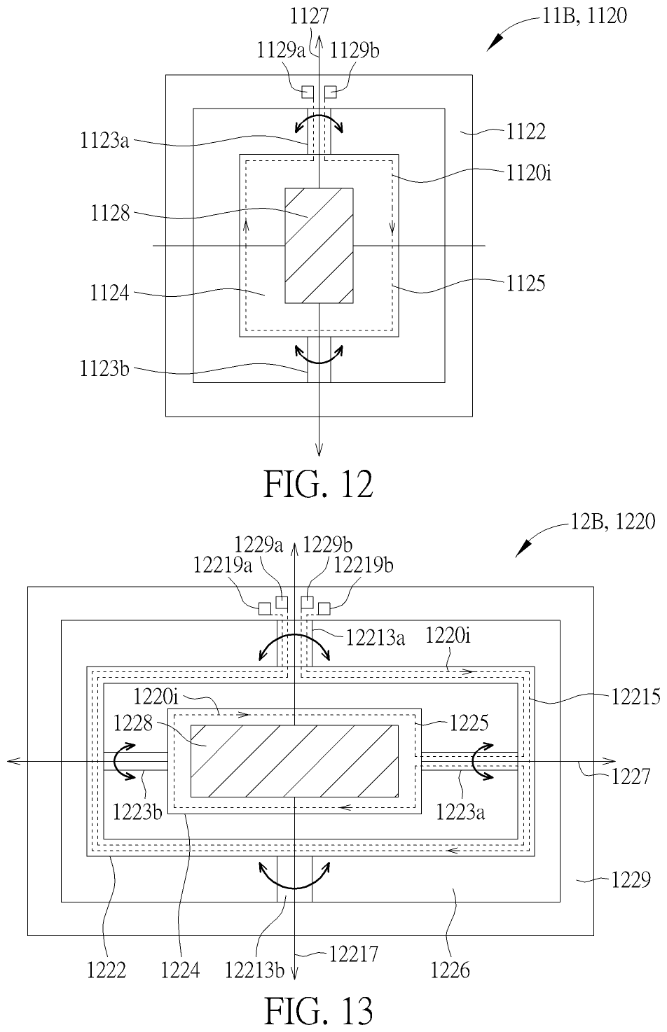

FIG. 12 is a schematic diagram of a LiDAR apparatus 11B according to an embodiment of the present invention. The LiDAR apparatus 11B may include a beam steering unit 1120 such as an electromagnetic-driven one-axis MEMS micro-mirror apparatus. The beam steering unit 1120 may include a micro-mirror surface 1128 disposed on top of a movable micro-mirror 1124, where the micro-mirror 1124 is supported to the substrate 1122 by two flexures 1123a and 1123b. The two flexures 1123a and 1123b are coaxially aligned along a flexure axis 1127. A coil 1125 is disposed on the micro-mirror 1124. When a current 1120i is applied to the coil through pads 1129a and 1129b under the influence of an external magnetic field perpendicular to current (not shown), such current generates a Lorentz force and the micro-mirror rotates about the flexure axis 1127 along the length of the flexure.

The beam steering unit 1120 may have several modes of motion: A) torsion mode (Mode 1): rotation around x-axis, B) trampoline mode; (Mode 2): translation in the z-axis: the micro-mirror slides out of plane; C) translation in the y-axis; (Mode 3): the micro-mirror slide in-plane along the y-axis; D) out-of-plane rocking mode (Mode 4): rotation around the y-axis; and E) in-plane rocking (Mode 5): the micro-mirror rotates around z-axis. The beam steering unit 1120 may be operated in two modes: resonant mode or non-resonant mode. The beam steering unit 1120 may be operated at resonant mode (Mode 1, 2, 3, 4, 5) when the AC current 1120i of frequency substantially equivalent to its resonant frequency is applied to the coil. For example, under primary resonant frequency mode (torsion mode, Mode 1), the micro-mirror rotates about the flexure axis and scans at its maximum amplitude achieving large FOV. In contrast, the beam steering unit 1120 may be operated at non resonant mode when an AC current 1120i with frequency not close to its resonant frequency (Mode 1) is applied to the coil where the micro-mirror rotates and scans at smaller amplitude thus achieving smaller field of view.

FIG. 13 is a schematic diagram of a LiDAR apparatus 12B according to an embodiment of the present invention. The LiDAR apparatus 12B may include a beam steering unit 1220 such as an electromagnetic-driven two-axis MEMS micro-mirror device. The beam steering unit 1220 may include a micro-mirror surface 1228 disposed on top of a movable micro-mirror 1224, where the micro-mirror is supported to a gimbal 1222 by two flexures 1223a, 1223b suspended in a cavity 1226. The two flexures 1223a and 1223b are coaxially aligned along a flexure axis 1227. The gimbal 1222 is in turn supported by two flexures 12213a, 12213b to a substrate 1229. The two flexures 12213a and 12213b are coaxially aligned along another flexure axis 12217.

The beam steering unit 1220 may have several modes of motion: 1) torsion mode: the micro mirror 1224 rotates around flexure axis 12217; 2) trampoline mode: the micro-mirror 1224 translates out of plane, perpendicular to the mirror surface 1228; 3) in-phase rocking mode: the micro-mirror 1224 rotates around flexure axis 1227 in phase with the gimbal 1222; and 4) out-of-phase rocking mode: the micro-mirror 1224 rotates around flexure axis 1227 out of phase with the gimbal 1222.

The beam steering unit 1220 may comprise two separate coils disposed on different substrates: a first (fast axis) coil 1225 on the micro-mirror 1224 and a second (slow axis) coil 12215 on the gimbal 1222.

When an first AC current 1220i of frequency substantially equivalent to either its in-phase rocking mode frequency or out of phase rocking mode frequency is applied to the first coil 1225 through pads 1229a and 1229b under the influence of a first external magnetic field along the second flexure axis 12217, the micro-mirror can pivot about the first flexure axis 1227 on either in-phase or out-of-phase rocking resonant mode achieving large FOV along the first flexure axis 1227 (fast axis). In one embodiment, when a second AC current 1220i of frequency substantially equivalent to the primary (lowest frequency) torsion mode frequency is applied to the second coil 12215 through pads 12219a and 12219b under the influence of a second external magnetic field along the first flexure axis 1227, the micro-mirror pivots about the second flexure axis 12217 at its torsion mode achieving large FOV along second flexure axis 12217 (slow axis). In another embodiment, when a second AC current 1220i of frequency not close to the primary torsion mode frequency is applied to the second coil 12215 through pads 12219a and 12219b under the influence of a second external magnetic field along the first flexure axis 1227, the micro-mirror pivots about the second flexure axis 12217 at its non-resonant torsional mode along second flexure axis 12217 (slow axis) achieving smaller FOV than that in its resonant torsional mode.

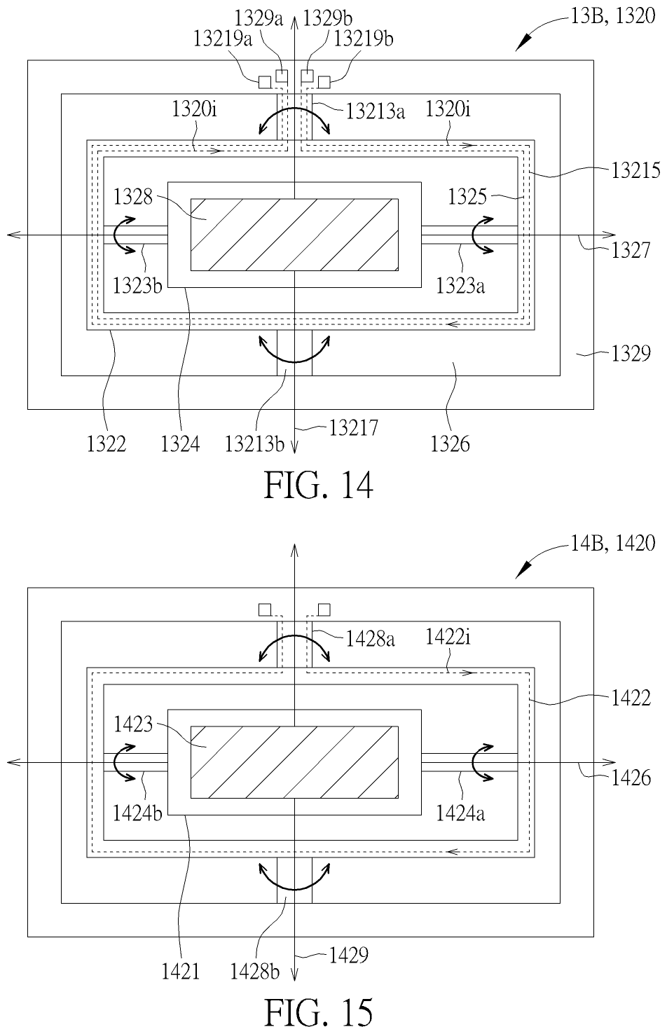

There are three embodiments of coil placements: 1) one coil on gimbal, another coil on mirror (as described in FIG. 13); 2) both coils on gimbal (see FIG. 14); and 3) only one coil on gimbal (see FIG. 15).

In one embodiment, both fast axis coil and slow axis coil are separately disposed on same gimbal. For example, FIG. 14 is a schematic diagram of a LiDAR apparatus 13B according to an embodiment of the present invention. The LiDAR apparatus 13B may include a beam steering unit 1320 such as an electromagnetic-driven two-axis MEMS micro-mirror device.

The beam steering unit 1320 may include a micro-mirror surface 1328 disposed on top of a movable micro-mirror 1324, where the micro-mirror is supported to a gimbal 1322 by two flexures 1323a, 1323b suspended in cavity 1326. The two flexures 1323a and 1323b are coaxially aligned along a flexure axis 1327. The gimbal 1322 is in turn supported by two flexures 13213a, 13213b to a substrate 1329. The two flexures 13213a and 13213b are coaxially aligned along another flexure axis 13217. At least two coils 1325, 13215 are disposed on the gimbal 1322. When a first AC sinusoidal current 1320i of a first resonant frequency (in-phase or out-of-phase mode frequency) is applied to the coil 1325 through pads 1329a and 1329b under the influence of an external magnetic field, the micro-mirror pivots about the flexure axis 1327 is under resonance mode. When a second AC sinusoidal current 1320i of a second frequency is applied to the second coil 13215 through pads 1329a and 1329b under the influence of an external magnetic field, the micro-mirror can pivot about the flexure axis 13217 (slow axis) generating a Lissajous pattern.

In another embodiment, only one coil is disposed on gimbal where a current comprising a first AC sinusoidal current component of fast axis frequency and a second AC sinusoidal current component of slow axis frequency component is applied to the coil. For example, FIG. 15 is a schematic diagram of a LiDAR apparatus 14B according to an embodiment of the present invention. The LiDAR apparatus 14B may include a beam steering unit 1420 such as an electromagnetic-driven two-axis MEMS micro-mirror device.

The beam steering unit 1420 may include a micro-mirror surface 1423 disposed on top of a movable micro-mirror 1421, where the micro-mirror is supported to the gimbal by two flexures 1424a, and 1424b. The two flexures are coaxially aligned along a flexure axis 1426. The gimbal is in turn supported by two flexures 1428a, and 1428b to a substrate. The two flexures are coaxially aligned along another flexure axis 1429. A coil 1422 for a current 1422i is disposed on the gimbal. When a AC sinusoidal current component of a first (fast axis) frequency closet to its in-phase or out-of-phase mode frequency and a second AC sinusoidal current component of a second (slow axis) frequency is applied to the coil 1422 under the influence of an external magnetic field (not shown), the micro-mirror pivots about the flexure axis 1426 at its in-phase or out-of-phase resonant mode and at the same time it can pivot about the flexure axis 1429.

In an embodiment, a LiDAR apparatus of the present invention may include a beam steering unit such as a MEMS micro-mirror device. The beam steering unit may be in the form of a MEMS micro-mirror array that includes a plurality of MEMS micro-mirrors.

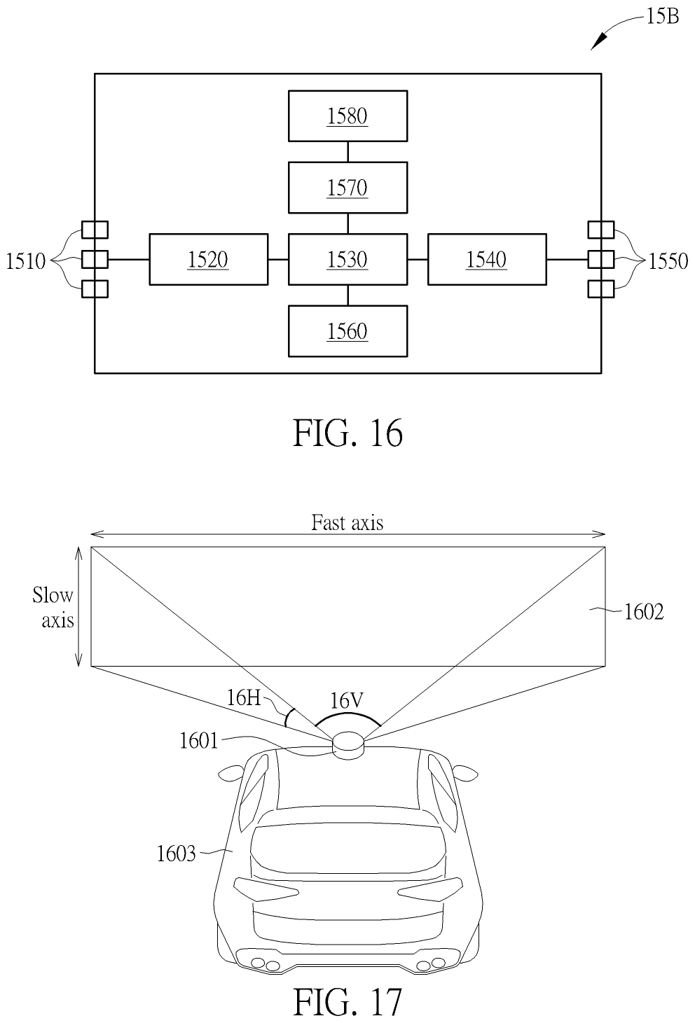

FIG. 16 is a schematic diagram of an electro-optical device 15B according to an embodiment of the present invention. The electro-optical device 15B comprises ingress ports 1510 and at least one transmitting unit (Tx) 1520, a central processing unit 1530, at least one receiving unit (Rx) 1540, egress ports 1550, a memory unit 1560, a MEMS control unit 1570, and a MEMS apparatus 1580.

The central processing unit 1530 processes data implementing by one or more computer chip(s) such as field programmable gate arrays (FPGAs), application specific integrated circuits (ASICs), digital signal processors (DSPs). The processing unit 1530 inputs data or control signals from the ingress ports 1510 through the egress ports 1550. The processing unit 1530 also stores and retrieves data, or program to and from the memory unit 1560. The memory unit 1560 may be in form of tape drives, solid state drives, or flash memory. The memory unit 1560 may be volatile, non-volatile, read-only memory (ROM), random access memory (RAM), ternary content-addressable memory (TCAM), static random-access memory (SRAM) and combination thereof. The processing unit 1530 also exports data to egress ports 1550 through transmitting unit 1540. The processing unit 1530 communicates with the MEMS control unit 1570 which in turns controls the MEMS apparatus 1580.

FIG. 17 is a schematic diagram of a LiDAR system according to an embodiment of the present invention. A LiDAR apparatus 1601 may be mountable on a vehicle 1603 to scan the environment 1602 around vehicle 1603. The LiDAR apparatus 1601 may be attached or mounted to any part of vehicle 1603.

The LiDAR apparatus 1601 may coordinate operation of a light transmitter or a light receiver with the movement of a beam steering unit in two axes: fast axis and slow axis in order to scan a field of view 16H and a field of view 16V. The beam steering unit may direct light projected towards the FOVs 16H and 16V. The light receiver may receive light reflected from the surroundings of vehicle 1603 in the FOVs 16H and 16V and transfer reflections signals indicative of light reflected from object(s) in the FOVs 16H and 16V to a central processing unit.

To sum up, the invention aims at disclosing a LiDAR system and method that comprises a light transmitter, an opto-mechanical beam steering device and a Geiger mode avalanche photodiode that generates high spatial angle resolutions within field of view where an opto-mechanical beam steering device could be MEMS based resonant mirror or mechanical based rotating mirror/prism.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scanning flash light detection and ranging (LiDAR) apparatus, comprising:
a light transmitter, wherein the light transmitter comprises a plurality of light sources, each of the plurality of light sources is configured to emit pulse light, and the pulse light is non-visible;
a beam steering unit, configured to steer the pulse light and reflected pulse light, wherein the reflected pulse light represents the pulse light reflected by at least one object; and
a light receiver, configured to capture the reflected pulse light, wherein the light receiver is a Geiger mode avalanche photodiode receiver comprising a plurality of light detectors, and the light transmitter, the beam steering unit, and the light receiver are disposed corresponding to each other,
wherein the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial.

2. The scanning flash LiDAR apparatus of claim 1, wherein the light transmitter is an edge-emitting laser source transmitter, a vertical cavity surface emitting laser (VCSEL) source transmitter emitting the pulse light, a fiber laser, or a photonic crystal surface emitting laser (PCSEL) source transmitter emitting the pulse light.

3. The scanning flash LiDAR apparatus of claim 1, wherein the plurality of light sources are arranged in a form of array or in a form of column or row, wherein the plurality of light sources is individually activated, able to be individually activated, illuminates homogeneously, illuminates in a row, or illuminates in a column.

4. The scanning flash LiDAR apparatus of claim 1, wherein the pulse light and the reflected pulse light are deflected or reflected by the beam steering unit as the beam steering unit scans in either a one-dimensional field of view or a two-dimensional field of view.

5. The scanning flash LiDAR apparatus of claim 1, wherein the pulse light from the light transmitter is deflected or reflected by the beam steering unit before the pulse light reflects off the at least one object to form the reflected pulse light, the reflected pulse light is deflected or reflected by the beam steering unit after the reflected pulse light is bent back from the at least one object, and the light receiver captures the reflected pulse light from the beam steering unit.

6. The scanning flash LiDAR apparatus of claim 1, further comprising:
an optical separator, configured to separate the reflected pulse light from the pulse light, wherein one of the pulse light and the reflected pulse light is redirected by the optical separator while the other of the pulse light and the reflected pulse light passes through the optical separator without changing direction, and the optical separator is a beam splitter or polarizing beam splitter.

7. The scanning flash LiDAR apparatus of claim 1, wherein a distance between the LiDAR apparatus and one of the at least one object is calculated by measuring a time delay between the pulse light and the reflected pulse light.

8. The scanning flash LiDAR apparatus of claim 1, wherein the beam steering unit includes a microelectromechanical systems (MEMS) based resonant mirror, and the MEMS based resonant mirror is driven by electrostatic mechanism, electromagnetic mechanism, thermal mechanism, or piezoelectric mechanism.

9. The scanning flash LiDAR apparatus of claim 1, wherein the beam steering unit includes a mechanical driven mirror or a mechanical driven prism, wherein the mechanical driven mirror is a polygon mirror, and the mechanical driven prism is a Risley prism.

10. The scanning flash LiDAR apparatus of claim 1, wherein the plurality of light detectors are positioned in a form of array or in a form of column or row, wherein each of the plurality of light detectors is configured such that it is individually activated, able to be individually activated such that it receives the reflected pulse light individually or homogeneously, or receives the reflected pulse light in a row or in a column.

11. The scanning flash LiDAR apparatus of claim 1, wherein a wavelength of the pulse light is 840 nm, 905 nm, 940 nm, 1330 nm, or 1550 nm.

12. A light detection and ranging (LiDAR) operating method, for a scanning flash LiDAR, comprising:
emitting pulse light from a light transmitter of the scanning flash LiDAR, wherein the light transmitter comprises a plurality of light sources, each of the plurality of light sources is configured to emit the pulse light, and the pulse light is non-visible;
steering reflected pulse light and the pulse light using a beam steering unit of the scanning flash LiDAR, wherein the reflected pulse light represents the pulse light reflected by at least one object; and
capturing the reflected pulse light by a light receiver of the scanning flash LiDAR, wherein the light receiver is a Geiger mode avalanche photodiode receiver comprising a plurality of light detectors,
wherein the pulse light incident on the beam steering unit and the reflected pulse light deflected by the beam steering unit are parallel or coaxial, or wherein the pulse light deflected by the beam steering unit and the reflected pulse light incident on the beam steering unit are parallel or coaxial.
